(19) United States
(12) Patent Application Publication
(10) Pub. No.: US 2018/0118260 A1
(43) Pub. Date: May 3, 2018

(54) POWER STEERING ADJUSTMENT DEVICE

(71) Applicant: Mitsubishi Electric Corporation, Tokyo (JP)

(72) Inventors: Reiko SAKATA, Tokyo (JP); Yoshimichi UMEKI, Tokyo (JP); Tsutomu MATSUBARA, Tokyo (JP)

(73) Assignee: Mitsubishi Electric Corporation, Tokyo (JP)

(21) Appl. No.: 15/569,876

(22) PCT Filed: Jul. 15, 2015
(86) PCT No.: PCT/JP2015/070262

§ 371 Date: Oct. 27, 2017

(51) Int. Cl. B62D 6/00; B62D 5/04; B60K 35/00

(52) U.S. Cl. CPC B62D 6/008; B62D 5/0463; B60K 2350/1004; B60K 2350/1076; B60K 35/00

(57) ABSTRACT

A guide set unit (3) sets an edit guide for adjusting steering feeling to steering control information. An adjustment information display unit (2) displays, on the same screen, a control characteristic graph visually representing the steering control information and the edit guide. A graph edit unit (4) edits the control characteristic graph using edit information when the edit information input unit (1) acquires the edit information.

### TECHNICAL FIELD

The present invention relates to a power steering adjustment device used for, for example, adjusting electric power steering (EPS).

### BACKGROUND ART

In EPS in general, steering control is adjusted in a development process of a vehicle according to development objects such that steering feeling of a steering wheel is optimized for a driver of the vehicle.

As a conventional technique of such an adjusting device, there is a technique in which a required editing amount is grasped as an intuitive or a sensuous amount by performing editing on a steering characteristic chart with visual inspection of the chart, and steering feeling is reconfigured to match development objects of a vehicle in a development process or individual characteristics of a driver (e.g. see Patent Literature 1).

In another technique, various steering feelings are obtained to match individual characteristics of a driver by editing and storing operation characteristics by clicking on or drawing a steering characteristic chart using a group of operation switches with visually checking steering characteristics displayed on a steering characteristics screen of a display device (e.g. see Patent Literature 2).

### CITATION LIST

### Patent Literature

Patent Literature 1: JP 2005-225430 A

Patent Literature 2: JP 2002-293257 A

### SUMMARY OF INVENTION

### Technical Problem

When adjusting steering feeling, it is important to edit the slope or the width of a graph related to steering control information. In the technique of the related art described in the above Patent Literatures 1 and 2, however, which part of and how to edit the graph in order to obtain desired steering feeling are not shown. Therefore, conventionally, for adjusting steering feeling, it is required to edit the slope or the width of the graph by inputting a plurality of array data values. There is thus a disadvantage that adjustment work is bothersome. As a result of this, a person who is not experienced enough with adjustment work has a difficulty to edit the graph. Further, there is a disadvantage that an area corresponding to steering feeling is different depending on the adjusting person.

The invention is devised in order to solve such disadvantages, and an object of the present invention is to provide a power steering adjustment device that enables a person who is not experienced enough with adjustment work to easily perform adjustment work of steering feeling.

### Solution to Problem

A power steering adjustment device according to the present invention includes: a guide set unit setting an edit guide for adjusting steering feeling representing steering feeling of a steering wheel of a vehicle to steering control information representing control information of assist power of steering; an adjustment information display unit displaying, on a same screen, a control characteristic graph visually representing the steering control information and the edit guide; an edit information input unit acquiring input information of edit information based on the edit guide; and a graph edit unit editing the control characteristic graph using the edit information when the edit information input unit acquires the edit information.

### Advantageous Effects of Invention

According to a power steering adjustment device of the present invention, an edit guide is set for adjusting steering feeling representing steering feeling of a steering wheel of a vehicle to steering control information representing control information of assist power of steering. As a result of this, even a person who is not experienced enough with adjustment work can easily perform adjustment work of steering feeling.

### BRIEF DESCRIPTION OF DRAWINGS

FIG. 1 is a configuration diagram illustrating a power steering adjustment device according to a first embodiment of the present invention;

FIG. 2 is a flowchart illustrating an operation of the power steering adjustment device according to the first embodiment of the present invention;

FIGS. 3A and 3B are explanatory diagrams illustrating display example of control characteristic graphs and edit guides of steering control information of the power steering adjustment device according to the first embodiment of the present invention;

FIGS. 4A and 4B are explanatory diagrams illustrating edit directions in the power steering adjustment device according to the first embodiment of the present invention;

FIGS. 5A and 5B are explanatory diagrams illustrating correcting operations by editing inputs in the power steering adjustment device according to the first embodiment of the present invention;

FIGS. 6A and 6B are explanatory diagrams of an example where handles are provided at each edit point in the power steering adjustment device according to the first embodiment of the present invention;

FIGS. 7A to 7C are explanatory diagrams illustrating a first editing method of the power steering adjustment device according to the first embodiment of the present invention;

FIGS. 8A to 8C are explanatory diagrams illustrating a second editing method of the power steering adjustment device according to the first embodiment of the present invention;

FIGS. 9A to 9C are explanatory diagrams illustrating a third editing method of the power steering adjustment device according to the first embodiment of the present invention;

FIGS. 10A and 10B are explanatory diagrams illustrating examples where display of control characteristic graphs of the power steering adjustment device according to the first embodiment of the present invention is changed depending on the steering feeling; and

FIGS. 11A and 11B are explanatory diagrams illustrating examples where feeling information is displayed for each area of control characteristic graphs of the power steering adjustment device according to the first embodiment of the present invention.

### DESCRIPTION OF EMBODIMENTS

To describe the present invention further in detail, some embodiments for carrying out the present invention will be described below with reference to the accompanying drawings.

### First Embodiment

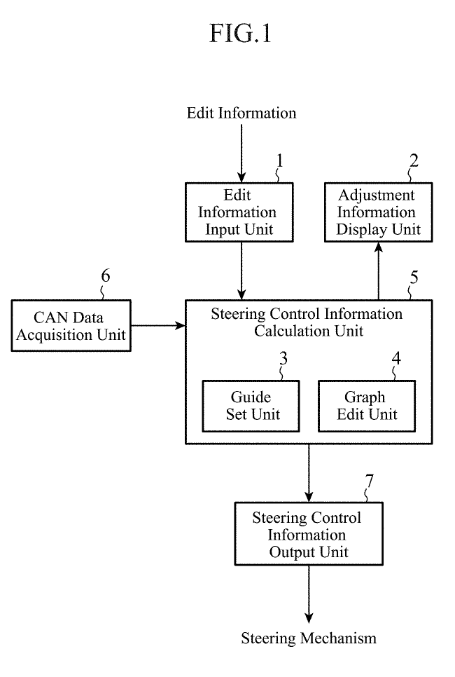

FIG. 1 is a configuration diagram illustrating a power steering adjustment device of this.

The power steering adjustment device according to this embodiment includes an edit information input unit 1, an adjustment information display unit 2, a guide set unit 3, a graph edit unit 4, a CAN data acquisition unit 6, and a steering control information output unit 7 as illustrated in FIG. 1.

The edit information input unit 1 is a processing unit that acquires edit information input by a user of the power steering adjustment device. The adjustment information display unit 2 displays a control characteristic graph and an edit guide of steering control information output from the guide set unit 3 and the graph edit unit 4 on the same screen. Note that, the edit information input unit 1 and the adjustment information display unit 2 are composed by using a device having a touch panel that performs screen display and accepts input on the screen such as an in-vehicle navigation device, a smartphone, and a tablet terminal; however, the edit information input unit 1 and the adjustment information display unit 2 may be separate devices. The guide set unit 3 is a processing unit that sets an edit guide for adjusting steering feeling representing steering feeling of a steering wheel to a graph representing steering control information that is control information of assist power of steering. The graph edit unit 4 is a processing unit that edits a control characteristic graph of steering control information when the edit information input unit 1 accepts input of the edit information. The guide set unit 3 and the graph edit unit 4 form a steering control information calculation unit 5 that calculates the steering control information.

The steering control information may be a single value or array data of two or three variables. In the case of two or three variables, representation by a graph having two or three dimensions is possible. For example, a control characteristic graph such as “steering angle and steering torque value”, “reaction force received from road surface and motor compensating current”, “steering torque and motor compensating current”, “steering angle, steering torque value, and vehicle speed”, “reaction force received from road surface, motor compensating current, and vehicle speed”, or “steering toque, motor compensating current, and vehicle speed” may be used. Steering feeling is a value representing feeling of steering that an operator feels when operating a steering wheel of a vehicle. For example, the following four types of values are included.

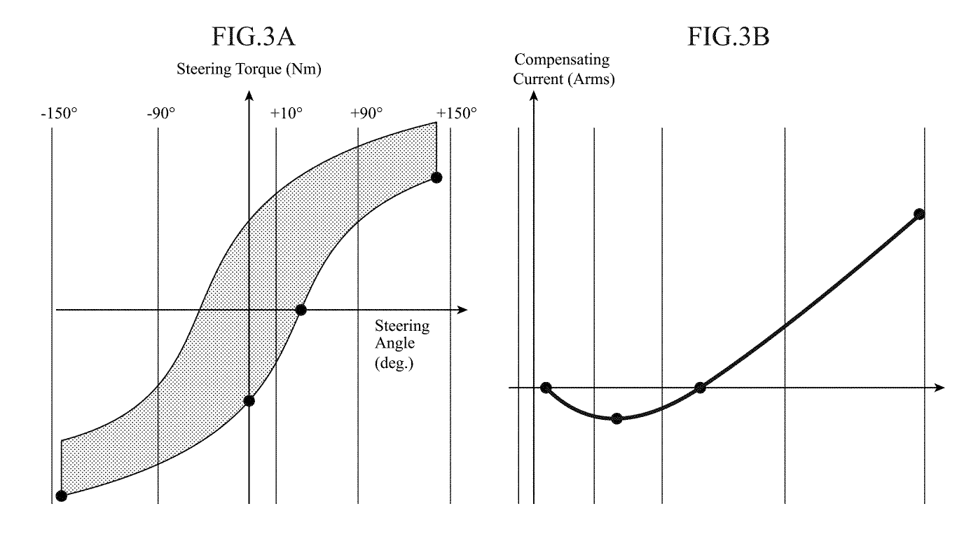

The four types of feeling values are obtained from relation between the steering angle and the steering torque of a graph representing relation between the steering angle and the steering torque as illustrated in FIG. 3A which will be described later, for example. The respective feeling values are as follows.

On-center feeling: this value corresponds to a graph shape such as: the slope between the torque value and the steering angle near the steering angle of zero degree of a graph of “steering angle and steering torque”; the slope between the torque value and the steering angle when the torque value becomes zero in the graph of “steering angle and steering torque”; and the slope between the reaction force from a road surface and the compensating current near the reaction force from the road surface of 0 Nm in a graph of “reaction force from road surface and compensating current”.

Steering wheel return feeling: this value corresponds to a graph shape, when a vehicle speed is 40 km/h, for example, such as: the slope between the torque value and the steering angle near the steering angle of 60 degrees in a graph of “steering angle and steering torque”; and the slope between the reaction force from a road surface and the compensating current near the compensating current of 0 Arms in a graph of “reaction force from road surface and compensating current”.

Spring feeling: this value corresponds to a graph shape, when a vehicle speed is 40 km/h, for example, such as: a difference in torque values between increasing steering and reducing steering near the steering angle of 120 degrees in a graph of “steering angle and steering torque”; and the slope between the reaction force from a road surface and the compensating current near the compensating current of 0 Arms in a graph of “steering angle and compensating current” or “steering torque value and compensating current”.

Build-up feeling: this value corresponds to a graph shape, when a vehicle speed is 40 km/h, for example, such as: the slope between the torque values and steering angles at a steering angle around a range of 0 to 120 degrees in a graph of “steering angle and steering torque”; and the slope between the reaction force from a road surface and the compensating current near the compensating current of 0 Arms in a graph of “steering angle and compensating current” or “steering torque value and compensating current”.

The CAN data acquisition unit 6 is a function unit for acquiring controller area network (CAN) data and outputting the data to the steering control information calculation unit 5. The CAN data acquisition unit 6 also has a function of acquiring vehicle speed information or a steering wheel angle information from a vehicle simulator. As a result of this, by providing the vehicle speed information or the steering wheel angle information as a vehicle simulator, it is possible to perform edit work not only when the vehicle is travelling but also when the vehicle is stopped.

The steering control information output unit 7 is an interface unit for providing the steering control information calculated by the steering control information calculation unit 5 to a steering mechanism which is a target of power assistance such as an assist motor.

Next, operations of the first embodiment configured in the above manner will be described.

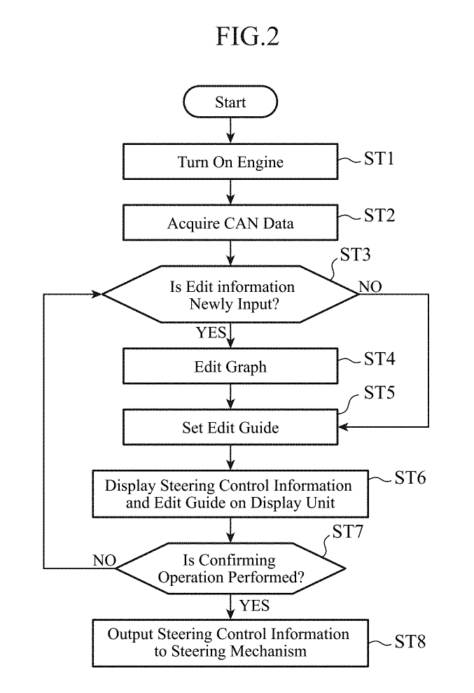

FIG. 2 is a flowchart illustrating operations of the power steering adjustment device according to the first embodiment.

First, when an engine of a vehicle is turned on (step ST1), in the power steering adjustment device, the CAN data acquisition unit 6 acquires CAN data (step ST2). Next, the power steering adjustment device determines whether new edit information is input from the edit information input unit 1 (step ST3). If no new edit information is input, a control characteristic graph of steering control information corresponding to a vehicle speed acquired in step ST2 and information of a predetermined edit guide are output to the adjustment information display unit 2 (step ST5). The adjustment information display unit 2 then displays, on the same screen, an edit guide based on the edit guide information acquired from the guide set unit 3 and the control characteristic graph of the steering control information corresponding to the vehicle speed (step ST6).

FIGS. 3A and 3B are explanatory diagrams illustrating display examples of the control characteristic graph and the edit guide of steering control information. As illustrated in the drawings, in a control characteristic graph of the steering control information, an edit point is arranged on the control characteristic graph in each area corresponding to the steering feeling divided by vertical lines. Note that, FIG. 3A shows steering control information representing relation between the steering angle and the steering torque, and FIG. 3B shows steering control information representing relation between various parameters and the compensating current. A control characteristic graph representing relation between steering angles and steering torque illustrated in FIG. 3A shows values integratedly representing control characteristic graphs as illustrated in FIG. 3B that represent relation between various parameters and the motor compensating current such as “relation between reaction force received from a road surface and motor compensating current”, “relation between steering torque and motor compensating current”, or the like. That is, the control characteristic graph illustrated in FIG. 3A represents values integrating the plurality of control characteristic graphs as illustrated in FIG. 3B based on sensibility of specialists highly experienced in driving. An adjusting person who is not a specialist can also perform adjustment by adjusting while checking feeling values since the feeling values are obtained from the control characteristic graph illustrated in FIG. 3A. In the example illustrated in FIGS. 3A and 3B, there are four edit points. The edit points shown in FIG. 3B correspond to the edit points in FIG. 3A, respectively.

Note that, in FIG. 3A, the range of the steering angle from −150 to 150 degrees is displayed; however, this steering angle changes in accordance with the vehicle speed. In this change, for example, the range of steering angle from −120 to 120 degrees is displayed at a vehicle speed of 40 km/h, and the range of steering angle from −150 to 150 degrees is displayed at a vehicle speed of 20 km/h.

The guide set unit 3 limits an edit direction of an edit point to a set direction such as X axis or Y axis directions, vertical directions, or horizontal directions.

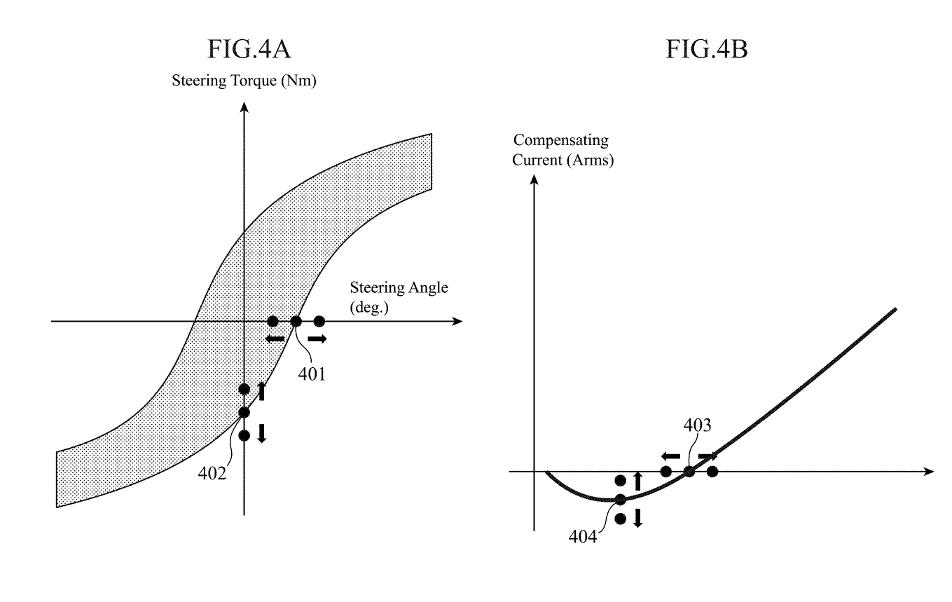

FIGS. 4A and 4B are explanatory diagrams illustrating edit directions. In FIG. 4A, the edit directions of an edit point 401 at a position intersecting with the X axis are limited to the X axis direction, and the edit directions of an edit point 402 at a position intersecting with the Y axis are limited to the Y axis direction. In FIG. 4B, the edit directions of an edit point 403 at a position intersecting with the X axis are limited to the X axis direction while edit directions of an edit point 404 not intersecting with the X axis nor the Y axis are limited to the vertical direction. Note that the limitation may be horizontal in accordance with the position of the edit point.

By limiting edit directions in the above manner, when a graph is edited using edit points, it is possible to change a graph with limiting the change in the graph to the value, slope, and swelling corresponding to feeling.

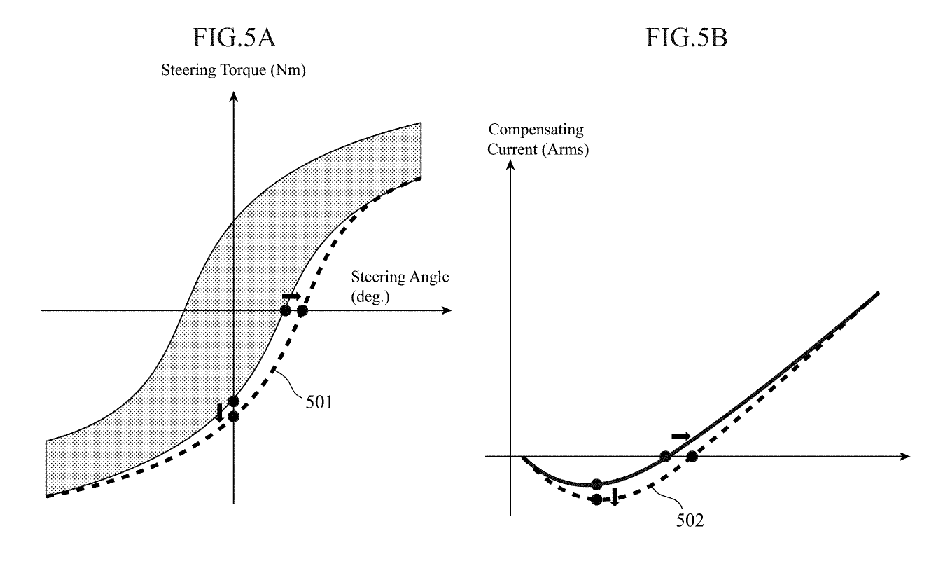

Next, a case where edit information is input from the edit information input unit 1 in step ST3 will be described. When the edit information for an edit point is input to the edit information input unit 1, the graph edit unit 4 performs correction on a graph displayed by the adjustment information display unit 2 (step ST4). FIGS. 5A and 5B are explanatory diagrams illustrating the correction. As illustrated by arrows 501 and 502 in these drawings, the graph edit unit 4 performs correction by an approximate curve such that the entire graph has a continuous shape. Further, the guide set unit 3 sets an edit guide to the graph corrected by the graph edit unit 4 (step ST5). As a result of this, the adjustment information display unit 2 displays the graph corrected in response to the input of the edit information to the edit information input unit 1 and a new edit guide corresponding to this control characteristic graph (step ST6).

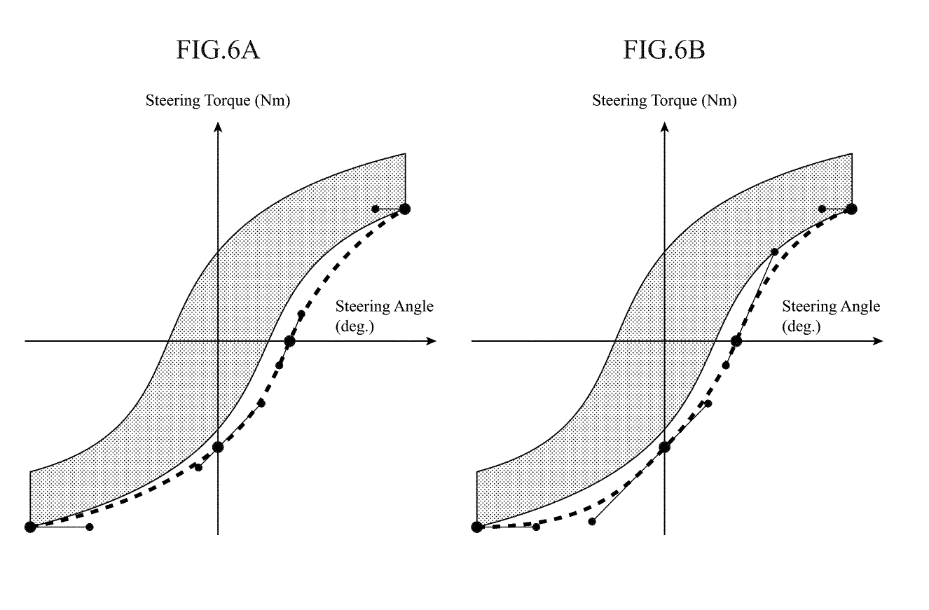

Alternatively, as illustrated in FIGS. 6A and 6B, handles may be provided to both sides of an edit point to edit a swelling between edit points by the slope and the length of the handles. Note that, an edit point arranged in an end point of a graph is provided with a handle only on an inner side of the graph. For example, when a graph is edited in step ST4, the guide set unit 3 sets edit points each of which has handles on both sides thereof as illustrated in FIGS. 6A and 6B. A handle is set to enable adjustment of the slope and the length from the edit point to the respective ends of the handles. An adjusting person can adjust a swelling of the graph by operating the handle. For example, the graph edit unit 4 performs correction such as increasing the swelling more as the handle is longer, and increasing the absolute value of the slope of the graph higher as the slope of the handle is steeper.

Further, the guide set unit 3 may limit the range of the slope or the length of a handle within which the handle can be edited. For example, when the absolute value of the slope of a handle is limited to 90 degrees or less, display of the handle does not move further from the position of the absolute value of 90 degrees when the handle is operated to have a slope larger than that and such input is not accepted. Moreover, for example, in a case where the length of handles are limited to avoid the handles respectively provided to two adjacent edit points from intersecting, when a value in the horizontal direction (X axis) of a handle provided to one of the edit points is input to be a value between the other edit point and a handle of the other edit point, display of the handle does not move from the position where the two handles have the same value in the horizontal direction (X axis).

In the above example, the guide set unit 3 sets an edit guide; alternatively, an editing method may be set.

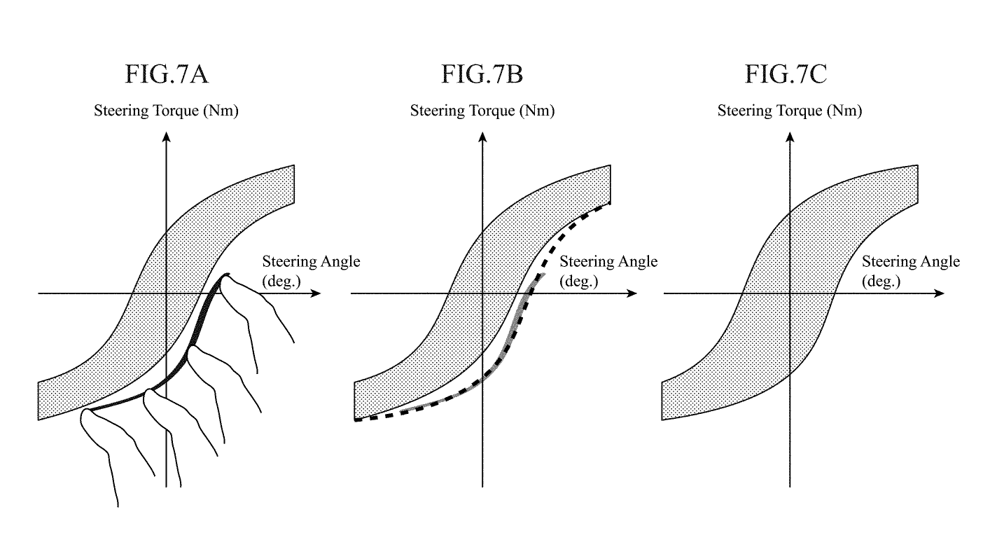

FIGS. 7A to 7C illustrate an example where a finger traces near a contour of a control characteristic graph of steering control information and a line corresponding to the movement of the finger is input as edit information. In this case, the guide set unit 3 sets, as an editing method, to recognize a curve as edit information when the curve is input near the graph as illustrated in FIG. 7A. When a curve is input near the graph, the edit information input unit 1 outputs this curve as edit information to the steering control information calculation unit 5. This allows the graph edit unit 4 to calculate a new graph line in accordance with the tracing line as illustrated in FIG. 7B and the adjustment information display unit 2 displays the new graph line. FIG. 7C shows such a graph.

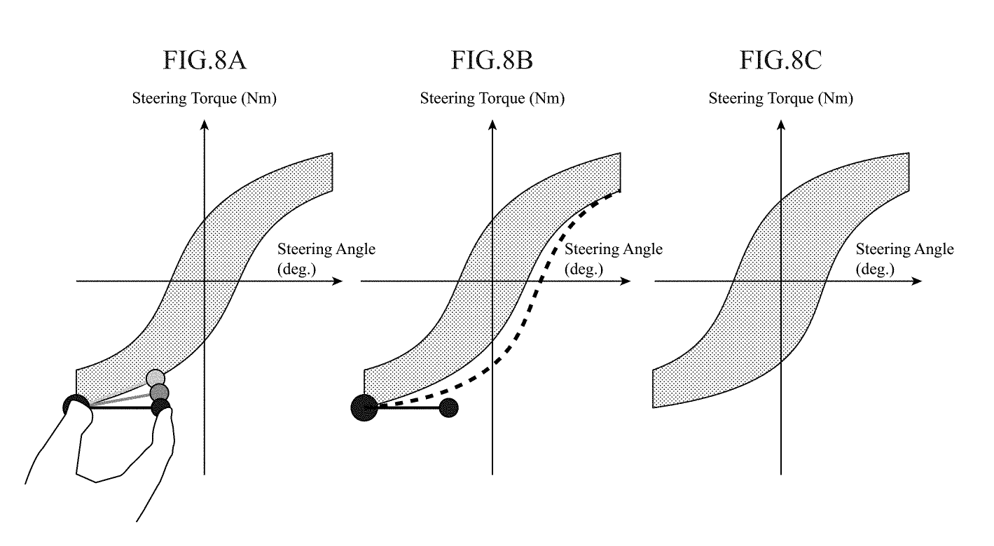

FIGS. 8A to 8C illustrate an example where two fingers move like a pair of compasses with one of them serving as an axis while the other rotationally moves to draw an arc with respect to a control characteristic graph of steering control information and a slope line connecting the two fingertips is input as edit information. In this case, when a line between a point serving as an axis and another point is input as an editing method as illustrated in FIG. 8A, the guide set unit 3 performs setting in which the input line is recognized as edit information. When such input is performed, the edit information input unit 1 outputs this as edit information to the steering control information calculation unit 5. This allows the graph edit unit 4 to calculate a new graph line in accordance with the slope line as illustrated in FIG. 8B and the adjustment information display unit 2 displays the new graph line as shown in FIG. 8C.

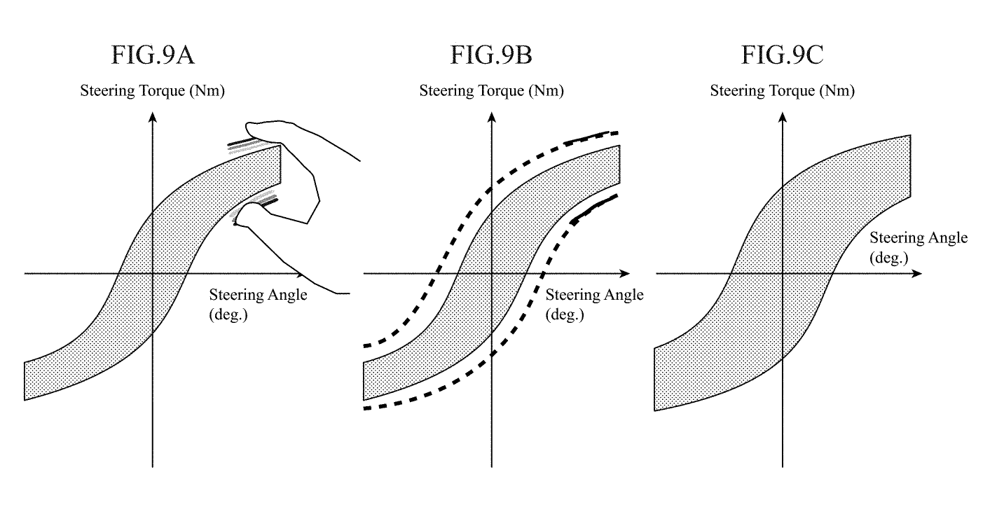

FIGS. 9A to 9C illustrate an example where the width of a graph is adjusted by movement of two fingers broadening or narrowing the width between the fingers with respect to a control characteristic graph of steering control information. In this case, the guide set unit 3 sets, as an editing method, to recognize movement as illustrated in FIG. 9A as edit information. That is, in this editing method, edit points are provided as two points positioned outside a plurality of curves or linear lines, and the distance between these two points is input as edit information. When such input is performed, the edit information input unit 1 outputs the distance between the two points as edit information of the line width to the steering control information calculation unit 5. This allows the graph edit unit 4 to calculate a new graph line in accordance with the line width of the edit information as illustrated in FIG. 9B and the adjustment information display unit 2 displays the new graph line. This is the graph illustrated in FIG. 9C. Such an editing method is effective especially for adjusting the spring feeling since the spring feeling corresponds to a difference in torque value around a steering angle of 120 degrees in a graph of “steering angle and steering torque”.

Note that input of edit information in FIGS. 7A to 9C is performed by a finger or fingers of an adjusting person; however, as long as one or two points can be specified in some way, input method is not limited to that using a finger or fingers.

After adjustment input as described above is performed, when confirming operation for a displayed content is performed by the adjustment information display unit 2 such as pressing on a confirmation button (not illustrated) (step ST7), the steering control information output unit 7 outputs the steering control information calculated by the steering control information calculation unit 5 to the steering mechanism (step ST8).

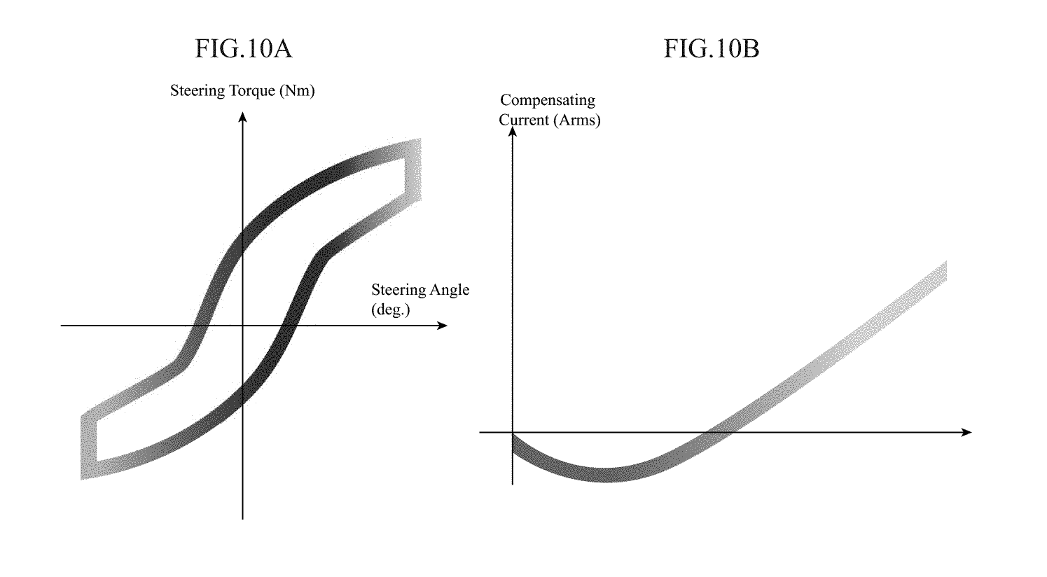

Note that, display may be changed depending on the steering feeling in a control characteristic graph of the steering control information displayed by the adjustment information display unit 2. FIGS. 10A and 10B are diagrams illustrating display examples in which the on-center feeling is illustrated in a dark color such as blue, and the steering wheel return feeling is illustrated in a pale color such as yellow. As a result of this, relation between steering control information and steering feeling can be clearly presented to an adjusting person.

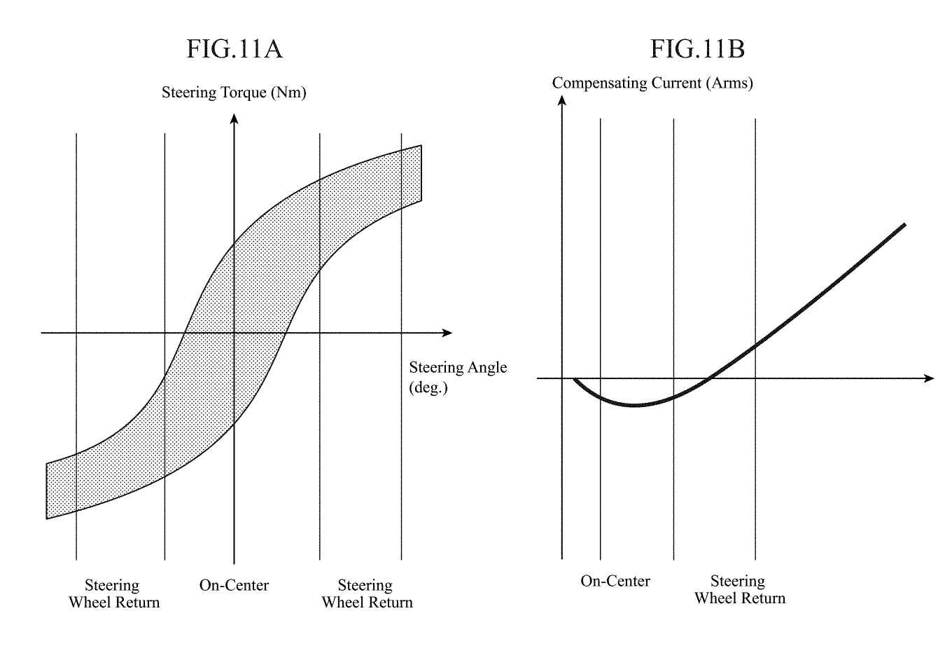

Further, as illustrated in FIGS. 11A and 11B, with displaying vertical lines for dividing the range along the X axis direction, the feeling information representing to which steering feeling each range corresponds to may be displayed.

The power steering adjustment device may be configured to display the control characteristic graph of display colors as illustrated in FIGS. 10A and 10B at first and to display edit points when a screen is touched.

As described above, the power steering adjustment device of the first embodiment includes: a guide set unit setting an edit guide for adjusting steering feeling representing steering feeling of a steering wheel of a vehicle to steering control information representing control information of assist power of steering; an adjustment information display unit displaying, on a same screen, a control characteristic graph visually representing the steering control information and the edit guide; an edit information input unit acquiring input information of edit information based on the edit guide; and a graph edit unit editing the control characteristic graph using the edit information when the edit information input unit acquires the edit information. Therefore, even a person who is not experienced with adjustment work can easily perform adjustment work of steering feeling.

According to the power steering adjustment device of the first embodiment, the guide set unit sets, as the edit guide, an edit point in an area of the control characteristic graph corresponding to the steering feeling. Thus, it is easy to determine which area of the control characteristic graph is to be edited to adjust steering feeling.

According to the power steering adjustment device of the first embodiment, the guide set unit sets the edit point on the control characteristic graph and limits an edit direction of the edit point to a set direction. Therefore, a control characteristic graph corresponding to the steering feeling can be easily obtained.

According to the power steering adjustment device of the first embodiment, the guide set unit corrects the control characteristic graph by an approximate curve when the edit point is edited. Therefore, a smooth control characteristic graph can be obtained even after editing is performed.

According to the power steering adjustment device of the first embodiment, the guide set unit sets edit points, each of which is the edit point, on the control characteristic graph being corrected, sets a handle on both sides or one side of each of the edit points, and corrects a slope and a swelling between the edit points in accordance with a slope and a length of the handle. Therefore, it is easy to adjust the control characteristics of the steering feeling desirably.

According to the power steering adjustment device of the first embodiment, the guide set unit sets an edit guide to limit at least one value of the slope and the length of the handle set to the both sides or the one side of the edit point within a set value. As a result, erroneous editing of steering feeling can be prevented.

The power steering adjustment device of the first embodiment includes: a guide set unit setting an editing method for adjusting steering feeling representing steering feeling of a steering wheel of a vehicle to steering control information representing control information of assist power of steering; an adjustment information display unit displaying a control characteristic graph visually representing the steering control information on a screen; an edit information input unit acquiring input information of edit information based on the editing method; and a graph edit unit editing the control characteristic graph using the edit information when the edit information input unit acquires the edit information of the editing method. Therefore, even a person who is not experienced with adjustment work can easily perform adjustment work of steering feeling.

According to the power steering adjustment device of the first embodiment, the editing method is to provide a curve or a linear line near a contour of the control characteristic graph as the edit information, and the graph edit unit calculates a new control characteristic graph in accordance with the curve or the linear line of the edit information when acquiring the edit information. Therefore, even a person who is not experienced with adjustment work can easily perform adjustment work of steering feeling.

According to the power steering adjustment device of the first embodiment, the editing method is to rotate one point with another point serving as an axis and to provide a slope of a line segment connecting the point and the other point, and the graph edit unit calculates a new control characteristic graph in accordance with the slope of a line between the point and the other point when acquiring the edit information. Therefore, even a person who is not experienced with adjustment work can easily perform adjustment work of steering feeling.

According to the power steering adjustment device of the first embodiment, the editing method is to set edit points as two points positioned outside a plurality of curves or linear lines and to edit a distance between the two points when a characteristic shown in a control characteristic graph is formed by the plurality of curves or linear lines, and the graph edit unit calculates a new control characteristic graph in accordance with the distance between the two points when acquiring the edit information. Therefore, even a person who is not experienced with adjustment work can easily perform adjustment work of steering feeling. In particular, as a steering feeling, the spring feeling can be easily adjusted.

According to the power steering adjustment device of the first embodiment, the adjustment information display unit displays an area of the control characteristic graph corresponding to a type of the steering feeling in a display color to discriminate the type of the steering feeling. Therefore, the area of the control characteristic graph corresponding to the steering feeling can be easily recognized.

According to the power steering adjustment device of the first embodiment, the adjustment information display unit divides the control characteristic graph into areas corresponding to the respective types of the steering feeling by dividing lines and displays to discriminate each of the areas. Therefore, the area of the control characteristic graph corresponding to the steering feeling can be easily recognized.

According to the power steering adjustment device of the first embodiment, the adjustment information display unit displays information of corresponding types of steering feeling for each of the areas, respectively. Therefore, an area of the control characteristic graph corresponding to the steering feeling can be easily recognized.

Note that, any component of the respective embodiments can be modified or omitted within the scope of the present invention.

### INDUSTRIAL APPLICABILITY

As described above, a power steering adjustment device according to the present invention relates to adjustment support upon performing adjustment of steering control of a vehicle and thus is suitable for use in adjustment of steering control when a vehicle is developed or a driver desires to change steering characteristics.

### REFERENCE SIGNS LIST

1: Edit information input unit, 2: Adjustment information display unit, 3: Guide set unit, 4: Graph edit unit, 5: Steering control information calculation unit, 6: CAN data acquisition unit, 7: Steering control information output unit.

1. A power steering adjustment device comprising:
a guide setter setting an edit guide for adjusting steering feeling representing steering feeling of a steering wheel of a vehicle to steering control information representing control information of assist power of steering;
an adjustment information display displaying, on a same screen, a control characteristic graph visually representing the steering control information and the edit guide;
an edit information inputter acquiring input information of edit information based on the edit guide; and
a graph editer editing the control characteristic graph using the edit information when the edit information inputter acquires the edit information.

2. The power steering adjustment device according to claim 1,
wherein the guide setter sets, as the edit guide, an edit point in an area of the control characteristic graph corresponding to the steering feeling.

3. The power steering adjustment device according to claim 2,
wherein the guide setter sets the edit point on the control characteristic graph and limits an edit direction of the edit point to a set direction.

4. The power steering adjustment device according to claim 3,
wherein the guide setter corrects the control characteristic graph by an approximate curve when the edit point is edited.

5. The power steering adjustment device according to claim 4,
wherein the guide setter sets edit points, each of which is the edit point, on the control characteristic graph being corrected, sets a handle on both sides or one side of each of the edit points, and corrects a slope and a swelling between the edit points in accordance with a slope and a length of the handle.

6. The power steering adjustment device according to claim 5,
wherein the guide setter sets an edit guide to limit at least one value of the slope and the length of the handle set to the both sides or the one side of the edit point within a set value.

7. A power steering adjustment device comprising:
a guide setter setting an editing method for adjusting steering feeling representing steering feeling of a steering wheel of a vehicle to steering control information representing control information of assist power of steering;
an adjustment information display unit displaying a control characteristic graph visually representing the steering control information on a screen;
an edit information inputter acquiring input information of edit information based on the editing method; and
a graph editer editing the control characteristic graph using the edit information when the edit information inputter acquires the edit information of the editing method.

8. The power steering adjustment device according to claim 7,
wherein the editing method is to provide a curve or a linear line near a contour of the control characteristic graph as the edit information, and
the graph editer calculates a new control characteristic graph in accordance with the curve or the linear line of the edit information when acquiring the edit information.

9. The power steering adjustment device according to claim 7,
wherein the editing method is to rotate one point with another point serving as an axis and to provide a slope of a line segment connecting the point and the other point, and
the graph editer calculates a new control characteristic graph in accordance with the slope of a line between the point and the other point when acquiring the edit information.

10. The power steering adjustment device according to claim 7,
wherein the editing method is to set edit points as two points positioned outside a plurality of curves or linear lines and to edit a distance between the two points when a characteristic shown in a control characteristic graph is formed by the plurality of curves or linear lines, and
the graph editer calculates a new control characteristic graph in accordance with the distance between the two points when acquiring the edit information.

11. The power steering adjustment device according to claim 1,
wherein the adjustment information display displays an area of the control characteristic graph corresponding to a type of the steering feeling in a display color to discriminate the type of the steering feeling.

12. The power steering adjustment device according to claim 1,
wherein the adjustment information display divides the control characteristic graph into areas corresponding to the respective types of the steering feeling by dividing lines and displays to discriminate each of the areas.

13. The power steering adjustment device according to claim 12,
wherein the adjustment information display displays information of corresponding types of steering feeling for each of the areas, respectively.
